(19) United States
(12) Patent Application Publication
(10) Pub. No.: US 2015/0356760 A1
(43) Pub. Date: Dec. 10, 2015

(54) CONTROL SYSTEM IN PROJECTION MAPPING AND CONTROL METHOD THEREOF

(71) Applicant: Shui Ho Hung, Taipei City (TW)

(72) Inventor: Shui Ho Hung, Taipei City (TW)

(21) Appl. No.: 14/474,478

(22) Filed: Sep. 2, 2014

Related U.S. Application Data
(60) Provisional application No. 62/008,523, filed on Jun. 6, 2014.

(51) Int. Cl. G06T 11/60; G06T 7/00; G06F 3/041

(52) U.S. Cl. CPC G06T 11/60; G06F 3/0416; G06T 7/0044

(57) ABSTRACT

A control system in projection mapping includes a processing unit, a touch panel, an image projection module and an image retrieving module. The processing unit is for executing an application program, the touch panel is coupled to the processing unit and for receiving a control motion and generating a control signal accordingly; the image projection module is coupled to the processing unit, the processing unit is for executing the control signal and controlling the image projection module to project a projection information through the application program; and the image retrieving module is coupled to the processing unit and for capturing the projection information as a first image information, wherein the processing unit is for selectively adding an image object to the first image information and regenerating a second image information through the application program, the image projection module reprojects a projection mapping information corresponding to the second image information.

### CROSS-REFERENCE TO RELATED APPLICATIONS

This application claims the benefit of the filing date of U.S. Provisional Application No. 62/008,523, filed on 2014 Jun. 6, in the United States Patent and Trademark Office, the disclosure of which is incorporated herein in its entirety by reference.

### BACKGROUND OF THE INVENTION

1. Technical Field

The present invention relates to a control system and a control method thereof, and more particularly to a control system in projection mapping and a control method thereof.

2. Description of Related Art

As rapid development of display technology, various new display device are getting rid of the stale and bringing forth the fresh, new products such as liquid crystal display (LCD), digital television, digital projector. Meanwhile, entirely separate development trend is derived in specific display device corresponding to different demands of consumers. One of development trend is family entertainment, to satisfy such demand, development of home display device, such as liquid crystal display (LCD), digital television, digital projector, etc are targeted in big-scale, high definition, high resolution and 3D imaging.

In another aspect, the other development trend is directed to personal use or commercial applications wherein convenience is no doubt a main subject. Hence, portable, mobility, multiple-function and power-saving are taking serious consideration in tablet computer, personal display device or small projector in order to be applied for personal use or commercial applications. Therefore, a tablet projector with both functions of tablet computer and projector integration is involved.

The advantages of the tablet projector includes: the tablet projector may perform like a normal tablet computer in common use, and the tablet projector may also project an image information in order to share with other viewers during commercial exhibition, presentation or image sharing, it is to say, it is convenient and fully satisfying user's different requirement with one tablet projector. Hence, a tablet projector has become a leading product in the market which is well-received by the public.

However, function of conventional tablet projector is still stricted to simple image projection, but lack of interactive operating function for users or audiences. On the other hand, image projection of the tablet projector admits to two-dimensional (2D) surface and cannot produce sufficient image corresponding to audience's visual angle. Besides, there is still room for application relating to image projection.

In view of the foregoing, there exist problems and disadvantages in the related art still unsolved. However, those skilled in the art sought vainly for a solution. There is an urgent need in the related field to provide a new operation method for the tablet projector.

### BRIEF SUMMARY OF THE INVENTION

In view of the above, the primary objective of the present invention is to provide a control system in projection mapping and a control method thereof so as to resolve defects such as restriction of image projection or lack of interactive operating function for users or audiences caused by conventional tablet projector and projection disruption derived therein.

Meanwhile, the control system in projection mapping and control method Thereof disclosed in present invention can extend not only to two-dimensional (2D) surface but also produce sufficient image corresponding to audience's visual angle. Furthermore, new projection control method and new interactive control application which are applied for tablet projector to satisfy user's or audience's demand and providing multiple feasibility for different projection control applications.

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one exemplary embodiment, the invention is directed to a control system in projection mapping, comprising a processing unit, a touch panel, an image projection module and an image retrieving module, the processing unit is configured for executing an application program; the touch panel is coupled to the processing unit and configured for receiving a control motion and generating a control signal accordingly; the image projection module is coupled to the processing unit and configured for executing the control signal and controlling the image projection module to project a projection information through the application program; and the image retrieving module is coupled to the processing unit and configured for capturing the projection information as a first image information, wherein the processing unit is configured for selectively adding an image object to the first image information and regenerating a second image information through the application program, the image projection module reprojects a projection mapping information corresponding to the second image information.

In another exemplary embodiment of mentioned control system in projection mapping, wherein the image retrieving module is configured for capturing a scene object in a real scene as the first image information, and measuring position of the scene object in the real scene as a first coordinate information, the processing unit is configured for measuring position of the image retrieving module in the real scene as a second coordinate information and calculating a projection parameter corresponding to the first coordinate information and the second coordinate information through the application program, wherein the processing unit acquires a third coordinate information corresponding to position where the image object is estimated to projected in the real scene, calculates a projection coordinate information according to the first coordinate information, the second coordinate information, the third coordinate information and the projection parameter and regenerates the second image information containing the image object through the application program as the processing unit is configured for selectively projecting the image object in the real scene, and the image projection module is configured for reprojecting the projection mapping information in the real scene corresponding to the second image information.

In another exemplary embodiment of mentioned control system in projection mapping, wherein the image retrieving module is configured for capturing the projection information persistently as the plurality of first image information during a time period, wherein the processing unit distinguishes each of the first image information containing the similar image object, compares position of the image object in each of the first image information and calculates displacement of the image object during the time period as a displacement information through the application program, wherein the processing unit identifies the displacement information corresponding to a control instruction, executes the control instruction and generates an execution result via the application program, and the image projection module is configured for reprojecting the projection mapping information according to the executing result.

According to the exemplary embodiment of the present disclosure, the invention is also directed to a control method in projection mapping which comprises following steps: receiving a control motion and generating a control signal via a touch panel accordingly; executing the control signal and controlling an image projection module to project a projection information through an application program via a processing unit; capturing the projection information as a first image information via an image retrieving module; selectively adding an image object in the first image information and regenerating a second image information through the application program via the processing unit; and reprojecting a projection mapping information corresponding to the second image information via the image projection module.

In another exemplary embodiment of mentioned control method in projection mapping further comprises following steps: capturing a scene object in a real scene as the first image information and measuring position of the scene object in the real scene as a first coordinate information via the image retrieving module; measuring position of the image retrieving module in the real scene as a second coordinate information through the application program via the processing unit; calculating a projection parameter corresponding to the first coordinate information and the second coordinate information through the application program via the processing unit; wherein as the processing unit selectively projects the image object in the real scene, the processing unit acquires a third coordinate information corresponding to position where the image object is estimated to projected in the real scene; the processing unit calculates a projection coordinate information according to the first coordinate information, the second coordinate information, the third coordinate information and the projection parameter and regenerates the second containing the image object through the application program; and the image projection module reprojects the projection mapping information in the real scene corresponding to the second image information.

In another exemplary embodiment of mentioned control method in projection mapping, wherein in step of calculating the projection parameter corresponding to the first coordinate information and the second coordinate information through the application program via the processing unit, the projection parameter is defined as (dₓ, d_{y}, d_{z}), the first coordinate information where the scene object located in the real scene is defined as (aₓ, a_{y}, a_{z}), the second coordinate information where the image retrieving module located in the real scene is defined as (cₓ, c_{y}, c_{z}), a shifting angle of the image retrieving module is defined as (ƒₓ, θ_{y}, θ_{z}); and the following formula is satisfied:

$$[ \begin{matrix}{d}_{x} \\ {d}_{y } \\ {d}_{z}\end{matrix} ] = [ \begin{matrix}1 & 0 & 0 \\ 0 & cos ( - {θ}_{x} ) & - sin ( {θ}_{x} ) \\ 0 & sin ( - {θ}_{x} ) & cos ( - {θ}_{x} )\end{matrix} ] [ \begin{matrix}cos ( - {θ}_{y} ) & 0 & sin ( - {θ}_{y} ) \\ 0 & 1 & 0 \\ - sin ( {θ}_{y} ) & 0 & cos ( - {θ}_{y} )\end{matrix} ] [ \begin{matrix}cos ( - {θ}_{z} ) & - sin ( - {θ}_{z} ) & 0 \\ sin ( - {θ}_{z} ) & cos ( - {θ}_{z} ) & 0 \\ 0 & 0 & 1\end{matrix} ] ( [ \begin{matrix}{a}_{x} \\ {a}_{y} \\ {a}_{z}\end{matrix} ] - [ \begin{matrix}{c}_{x} \\ {c}_{y} \\ {c}_{z}\end{matrix} ] ) .$$

In another exemplary embodiment of mentioned control method in projection mapping, wherein in step of calculating the projection parameter corresponding to the first coordinate information and the second coordinate information through the application program via the processing unit, position of the image retrieving module is remaining unchanged, the shifting angle (θₓ, θ_{y}, θ_{z})=(0,0,0), and the following formula is satisfied: (dₓ, d_{y}, d_{z})=(aₓ, a_{y}, a_{z})−(cₓ, c_{y}, c_{z}).

In another exemplary embodiment of mentioned control method in projection mapping, wherein in the step of calculating the projection coordinate information according to the first coordinate information, the second coordinate information, the third coordinate information and the projection parameter and regenerates the second image information containing the image object through the application program, the projection coordinate information is defined as (bₓ, b_{y}), the third coordinate information where the image object is estimated to projected in the real scene is defined as (eₓ, e_{y}, e_{z}), and the following formulae are satisfied:

$${b}_{x} = \frac{{e}_{x}}{{d}_{x}} {d}_{x} - {e}_{x}$$

$${b}_{z} = \frac{{e}_{z}}{{d}_{z}} {d}_{y} - {e}_{y} .$$

In another exemplary embodiment of mentioned control method in projection mapping further comprises following steps: capturing the projection information persistently as the plurality of first image information during a time period via the image retrieving module; distinguishing each of the first image information containing the similar image object through the application program via the processing unit; comparing position of the image object in each of the first image information and calculating displacement of the image object during the time period as a displacement information through the application program via the processing unit; identifying whether the displacement information corresponding to a control instruction via the processing unit, wherein if the displacement information is determined corresponding to the control instruction, the processing unit executes the control instruction and generates an execution result via the application program, and the image projection module reprojects the projection mapping information according to the executing result; or wherein if the displacement information is determined not corresponding to the control instruction, the processing unit is deactivated.

In another exemplary embodiment of mentioned control method in projection mapping, wherein in the step of identifying whether the displacement information corresponding to a control instruction via the processing unit, wherein if the displacement information is determined corresponding to a clicking instruction, the processing unit executes the clicking instruction and generates the execution result via the application program accordingly; wherein if the displacement information is determined corresponding to a sliding instruction, the processing unit executes the sliding instruction and generates the execution result via the application program accordingly.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

Firstly, through retrieving the projection information via the image retrieving module in the tablet projector, users are available for adding or modifying the image object immediately and reprojecting the projection mapping information which have been edited via the image projection module. Accordingly, present invention provides real-time projection image editing as to improve interaction with users and audiences.

Secondly, in present invention, through retrieving the real scene as the image information via the image retrieving module in the tablet projector, users may further add or modify the image object to the image information, and the image projection module reprojects the projection mapping information which have been edited accordingly. Therefore, mentioned projection mapping information can be projected in the real scene and provide audiences with a spectacular sense of actually being there. In another aspect, mentioned projection mapping theory may also applied for projecting particular image on a three-dimensional (3D) object and projection angle can be verified corresponding to users' view angle, hence the projection mapping information projected on a surface of the object is seemed natural and visual effect is improved strongly. Effective of projection mapping and augmented reality will satisfy audience's demand and provide vicarious pleasure.

Furthermore, through retrieving the image information via the image retrieving module in the tablet projector during a time period, displacement of the image object during the time period is identified and the control instruction corresponding to the displacement is determined accordingly. The control instruction is executed and the execution result will be projected by the image projection module. Hence, users' operation can direct to the projection image, the operation is determined through the control method in projection mapping and the execution result is projected by the image projection module accordingly. Consequently, real-time interaction between users and the table projector through operating direct to the projection image is fulfilled correspondingly.

In conclusion, the control system in projection mapping and the control method thereof disclosed in present invention not only provide basic image projection, but also produce various image result through user's interactive operation. Besides, image projection in present invention may combine with real scene and is not limited to project on two-dimensional (2D) surface. Accordingly, usefulness and range of image projection mapping applications is improved remarkably, which includes experiential exhibition, commercial, education as to satisfy user's different demands.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the subsequent detailed description and examples with references made to the accompanying drawings, wherein:

FIG. 1 is a structural diagram illustrating a control system in projection mapping according to an exemplary embodiment of the present invention;

FIG. 2 is a functional block diagram illustrating the control system in projection mapping according to the exemplary embodiment of the present invention;

FIG. 3 is a flow chart illustrating a control method in projection mapping according to an exemplary embodiment of the present invention;

FIG. 4A is a schematic diagram illustrating the control method in projection mapping according to the exemplary embodiment of the present invention;

FIG. 4B is a schematic diagram illustrating the control method in projection mapping according to the exemplary embodiment of the present invention;

FIG. 4C is a schematic diagram illustrating the control method in projection mapping according to the exemplary embodiment of the present invention;

FIG. 4D is a schematic diagram illustrating the control method in projection mapping according to the exemplary embodiment of the present invention;

FIG. 5 is a flow chart illustrating the control method in projection mapping according to another exemplary embodiment of the present invention;

FIG. 6A is a schematic diagram illustrating the control method in projection mapping according to the other exemplary embodiment of the present invention;

FIG. 6B is a schematic diagram illustrating the control method in projection mapping according to the other exemplary embodiment of the present invention;

FIG. 6C is a schematic diagram illustrating the control method in projection mapping according to the other exemplary embodiment of the present invention;

FIG. 7A is a schematic diagram illustrating the control method in projection mapping according to the other exemplary embodiment of the present invention;

FIG. 7B is a schematic diagram illustrating the control method in projection mapping according to the other exemplary embodiment of the present invention;

FIG. 7C is a schematic diagram illustrating the control method in projection mapping according to the other exemplary embodiment of the present invention;

FIG. 8 is a flow chart illustrating the control method in projection mapping according to another exemplary embodiment of the present invention;

FIG. 9A is a schematic diagram illustrating the control method in projection mapping according to the other exemplary embodiment of the present invention;

FIG. 9B is a schematic diagram illustrating the control method in projection mapping according to the other exemplary embodiment of the present invention;

FIG. 9C is a schematic diagram illustrating the control method in projection mapping according to the other exemplary embodiment of the present invention; and

FIG. 9D is a schematic diagram illustrating the control method in projection mapping according to the other exemplary embodiment of the present invention.

### DETAILED DESCRIPTION OF THE INVENTION

The detailed description and technical contents of the present invention will be explained with reference to the accompanying drawings. However, the drawings are for illustration only and cannot be used to limit the present invention.

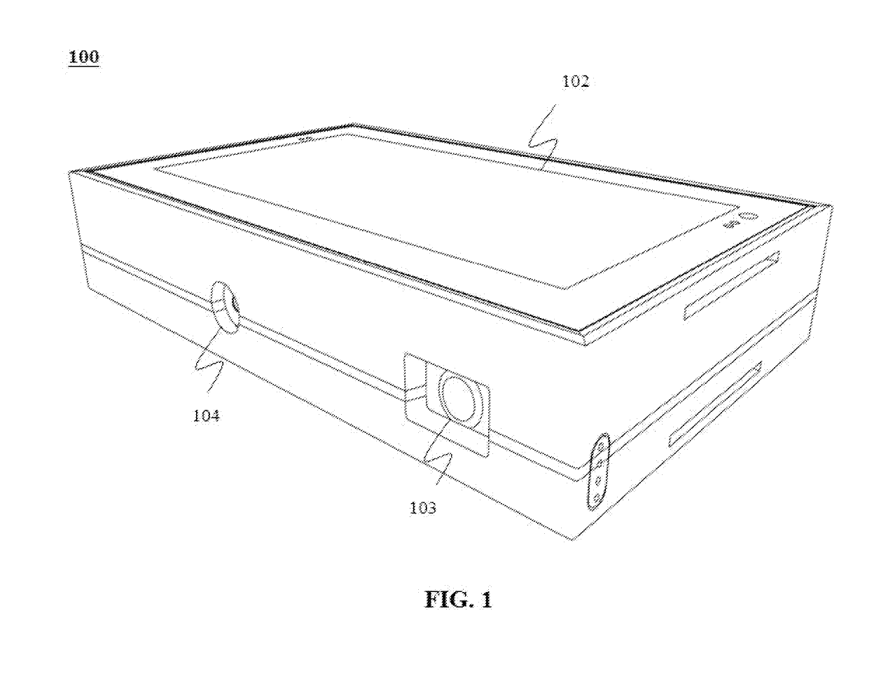

Several exemplary embodiments of the present disclosure are described with reference to FIGS. 1 through 9D, which generally relate to a control system in projection mapping and a control method thereof. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The control system in projection mapping and the control method thereof disclosed in present invention include three embodiments, which applicants will explain as follow.

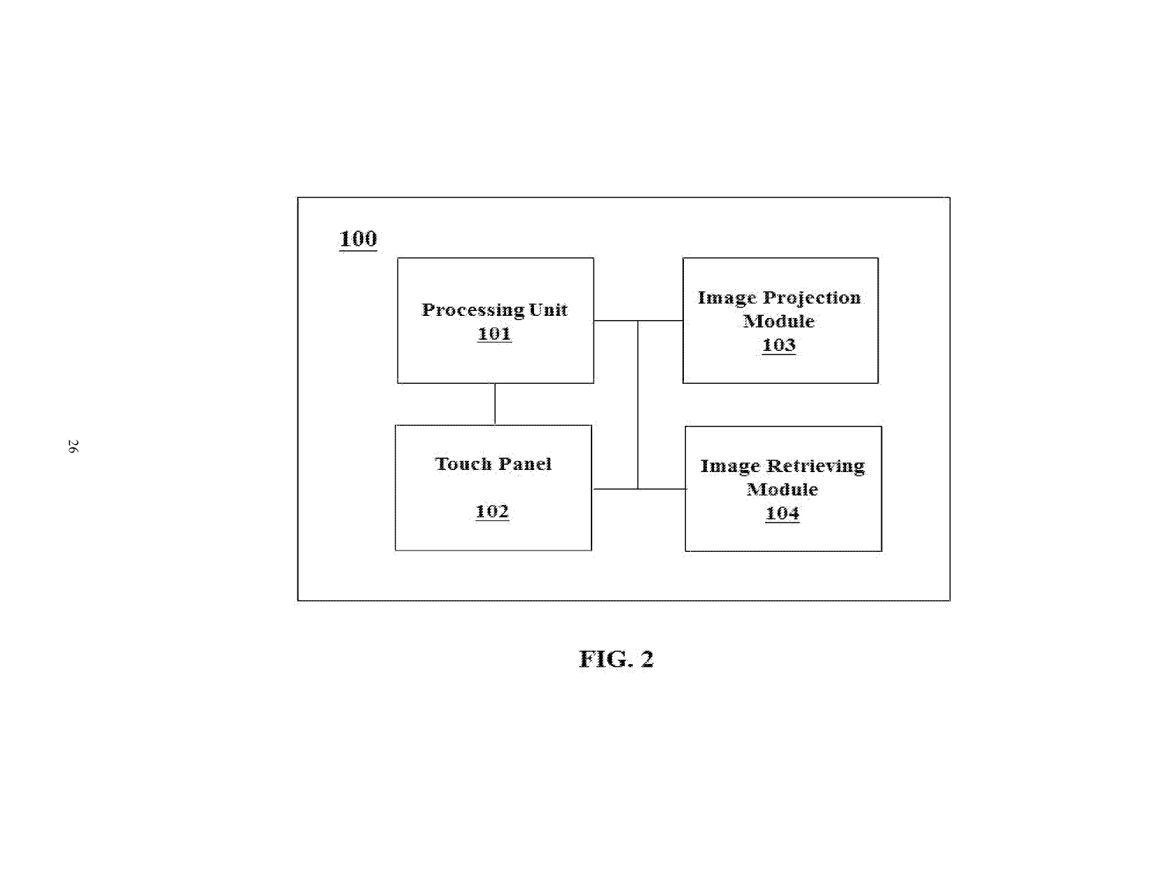

FIG. 1 to FIG. 2 are a structural diagram and a function block diagram illustrating a control system in projection mapping according to a first embodiment of the present invention. Referring to FIG. 1 to FIG. 2, the control system in projection mapping 100 in the first embodiment can be but not limited to a mobile projector, a tablet computer or a laptop equipped with image projecting module. The control system in projection mapping 100 includes a processing unit 101, a touch panel 102, an image projection module 103 and an image retrieving module 104. An application program is executed by the processing unit 101. The application program mentioned herein includes a presentation, image processing, video processing or other relating application software which is applied in a mobile projector and is not limited.

As mentioned above, in the control system in projection mapping 100, the touch panel 102 is coupled to the processing unit 101, configured for receiving a control motion for users and generating a control signal accordingly. The processing unit 101 is configured for executing the control signal through the application program. The image projection module 103 is coupled to the processing unit 101 and controlled to project a projection information corresponding to the control signal by the processing unit 101. The image retrieving module 104 is coupled to the processing unit 101. Since the image retrieving module 104 is disposed on the same side with the image projection module 103 on the tablet projector in present invention, the image retrieving module 104 is configured for capturing the projection information as a first image information. The first image information is edit by the processing unit 101 and a second image information is regenerated by the processing unit 101 according to user's instruction or operation. The image projection module 104 will reproject a projection mapping information corresponding to the second image information which has been edited controlled by the processing unit 101. Detail operating procedure will be expatiated.

It is noted that the control system in projection mapping 100 illustrated in this embodiment may include other hardware components, such as optical detection module applied for gesture operation, audio playback module or network connection module and is not limited as mentioned. The following description will focus on essential components in the control system in projection mapping 100 as shown in FIG. 1 and FIG. 2 for emphasizing the technical features of the present invention. It will also make the description of the present invention clear enough and fully disclosed for people with ordinary skill in this art to practice according thereto.

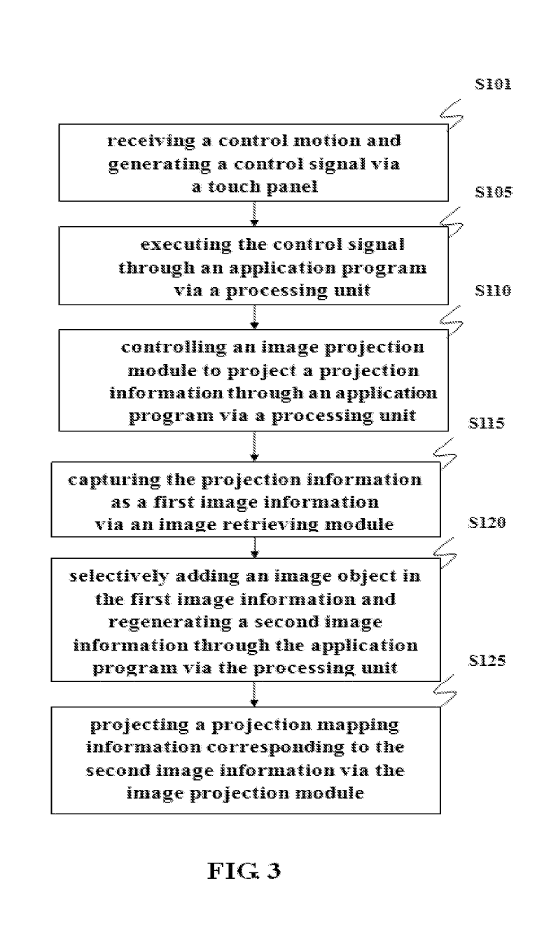

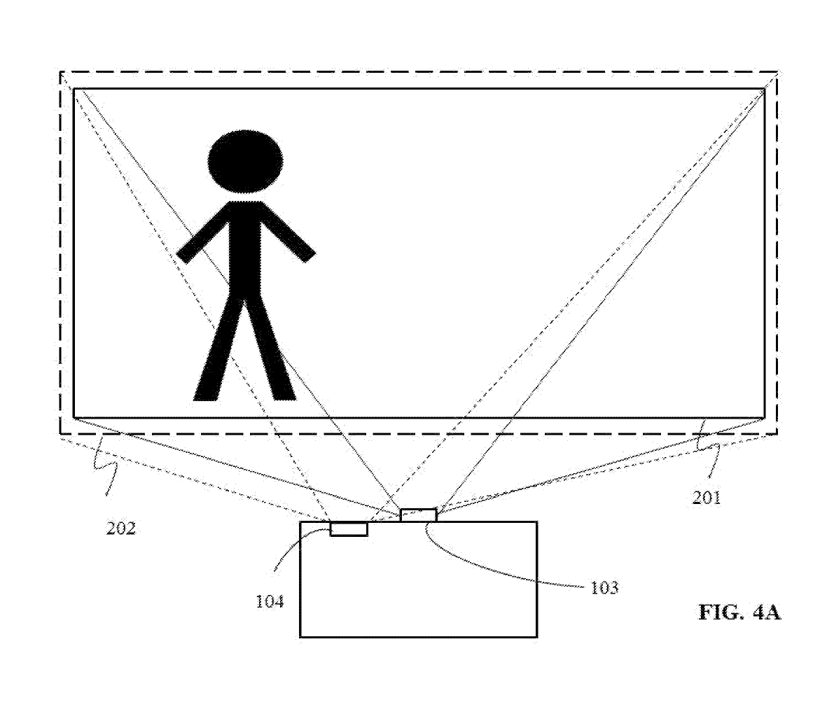

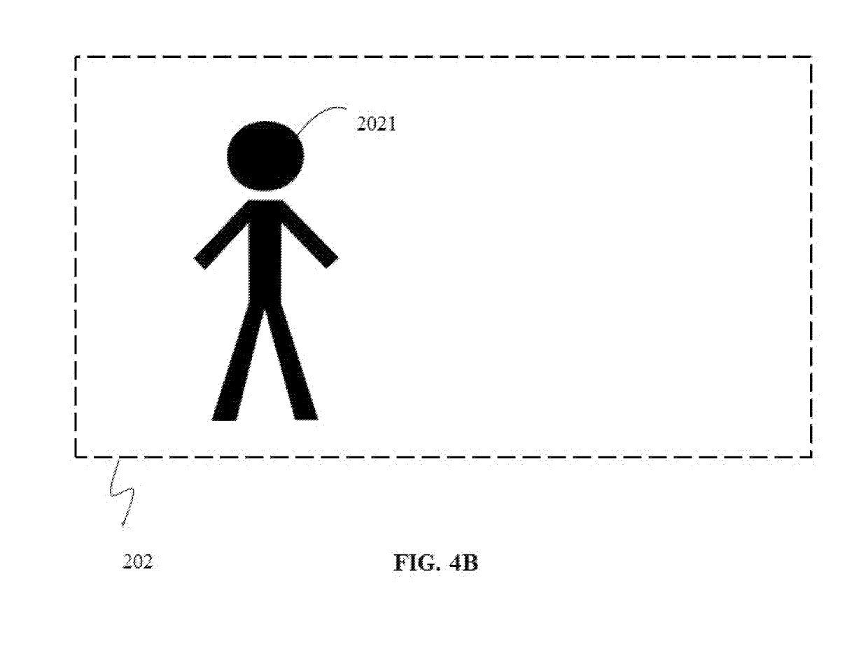

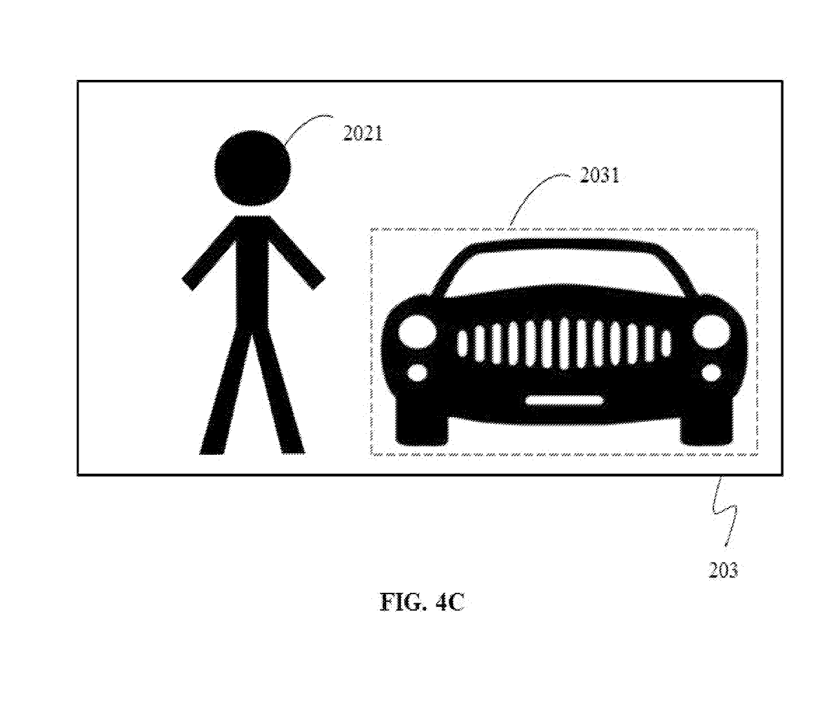

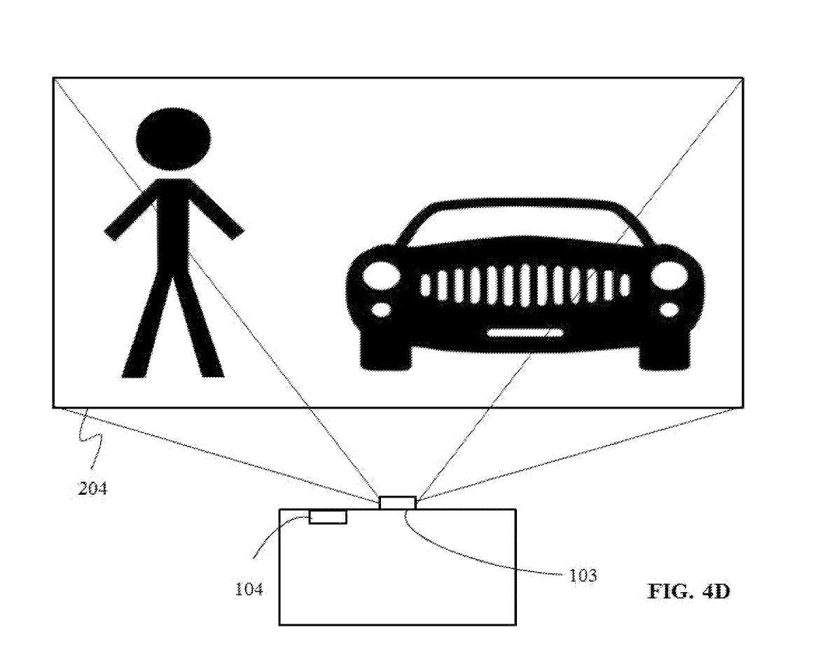

As mentioned above, please referring to FIG. 3A to 4D, also referring to FIG. 1 and FIG. 2, when users operate the control method in the control system in projection mapping as disclosed on this embodiment, firstly, users operate the tablet projector to project an image. Therefore, the touch panel 102 receives the control motion and generates the control signal accordingly (S101), the processing unit 101 executes the control signal through an application program (S105), and the processing unit 101 controls the image projection module 103 to project the projection information 201 (S110). Accordingly, the image projection module 103 projects the projection information 201 corresponding to user's operation. The image retrieving module 104 captures the projection information 201 as a first image information 202 (S115), since the image projection module 103 and the image retrieving module 104 are disposed on the same side of the tablet projector and adjacent to each other, scope of the first image information 202 is essentially equal to scope of the projection information 201. As result, while users attempt to edit current projection information 201, they may select to edit the first image information 202 via the touch panel 102 or other input module, or add different elements on it. In the following illustration, applicants will take adding an image object 2031 as example but it is not limited:

As mentioned above, in FIG. 4B, the processing unit 101 will read-in the first image information 202 through the application program and determine the first image information 202 contains an image object 2021, such as a person. While users want to add another image object, such as a car, next to the person, the processing unit 101 will selectively adding an image object 2031—a car to the first image information 202 and regenerate a second image information 203 (S120). Hence, the second image information 203 regenerated includes the original image object 2021 and new image object 2031, the processing unit 101 control the image projection module 103 to project a projection mapping information 204 corresponding to the regenerated second image information 203.

Accordingly, in this embodiment, users may edit the projection image or add other image object to the projection image directly during image projection as to expand interactive function between the table projector and users. In addition, visual effect for audience is expected to improve remarkably.

The control system in projection mapping disclosed in a second embodiment is Similar to the first embodiment, difference between the second embodiment and the first embodiment is that main objective in this embodiment is practicing projection mapping in order to achieve augmented reality. Following are two different aspects of mentioned control system:

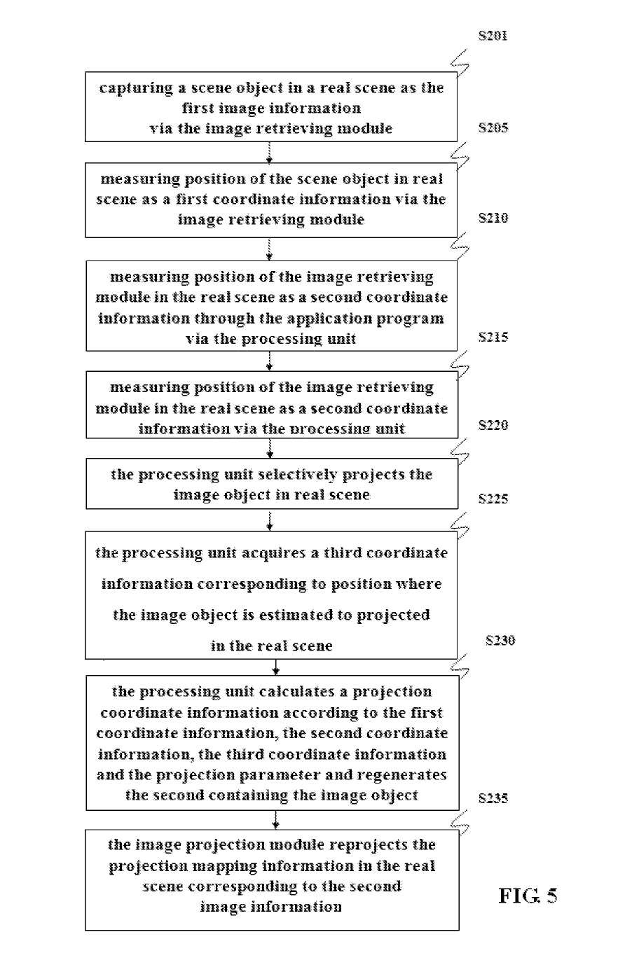

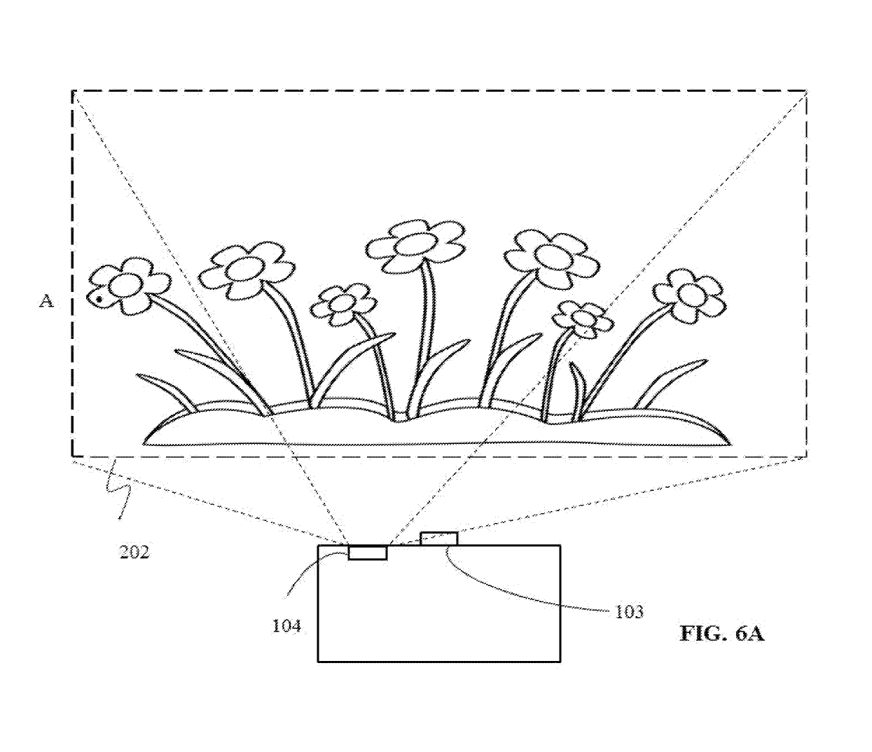

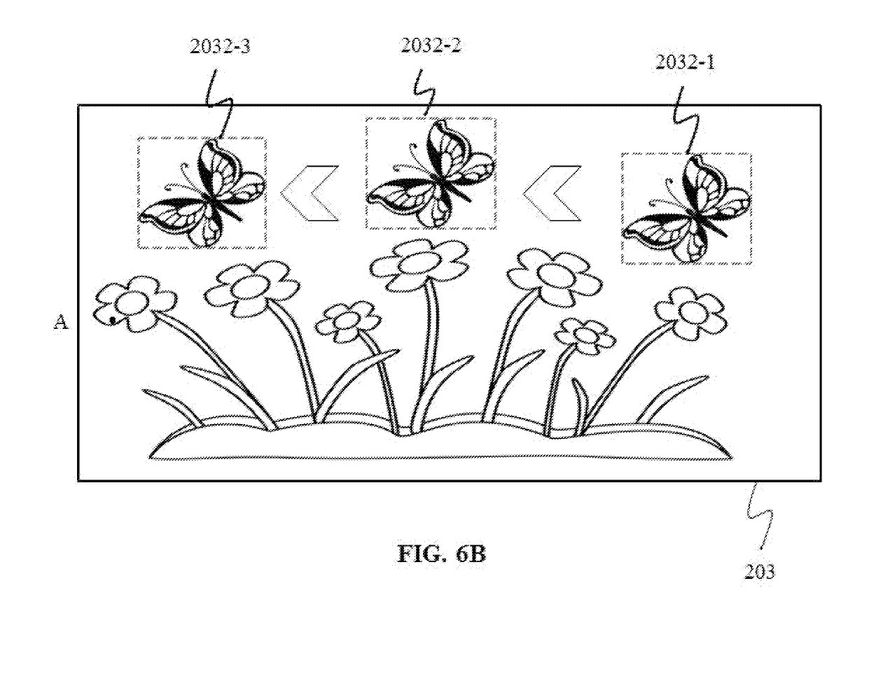

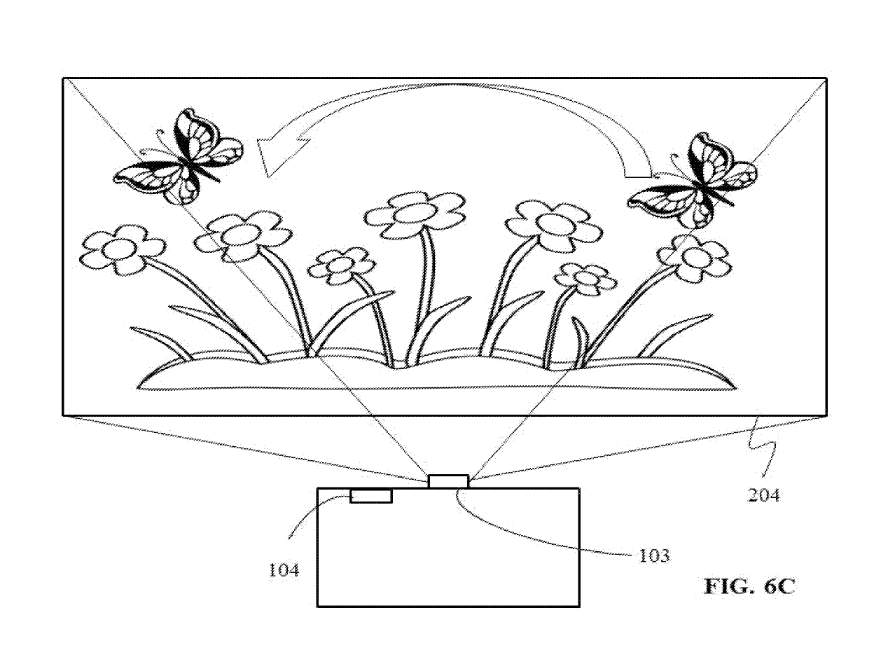

Demand in the first aspect of mentioned control system is to add required image in the real scene and merge together. Referring to FIG. 5 to FIG. 6C, users operate the image retrieving module 104 to capture a scene object in the real scene, such as flowering shrubs, as the first mage information 202 (S201) and measure position of the scene object in the real scene, such as one of the flower in mentioned flowering shrubs, as a first coordinate information A (S205). It is noted that such coordinate information measurement is directed to whole outline of the scene object, however to simplify explanation in following paragraphs, the first coordinate information A will be taken as representative and expressed as (aₓ, a_{y}, a_{z}) first. The processing unit 101 calculates position of the image retrieving module 103 in the real scene as a second coordinate information C via the application program and the second coordinate information C is expressed as (cₓ, c_{y}, c_{z}). The processing unit 101 calculates a projection mapping parameter D corresponding to the first coordinate information A and the second coordinate information B through the application program and the projection mapping parameter D is defined as (dₓ, d_{y}, d_{z}) (S215). The calculation formula of projection mapping parameter D is determined according to whether the image retrieving module 104 will be moved, it is to say that whether position of the image retrieving module 104 will be changed in the following projection mapping, if so, shifting angle of the image retrieving module 104 is defined as (θₓ, θ_{y}, θ_{z}), and the projection mapping parameter D (dₓ, d_{y}, d_{z}) can be acquired by following formula:

$$[ \begin{matrix}{d}_{x} \\ {d}_{y } \\ {d}_{z}\end{matrix} ] = [ \begin{matrix}1 & 0 & 0 \\ 0 & cos ( - {θ}_{x} ) & - sin ( {θ}_{x} ) \\ 0 & sin ( - {θ}_{x} ) & cos ( - {θ}_{x} )\end{matrix} ] [ \begin{matrix}cos ( - {θ}_{y} ) & 0 & sin ( - {θ}_{y} ) \\ 0 & 1 & 0 \\ - sin ( {θ}_{y} ) & 0 & cos ( - {θ}_{y} )\end{matrix} ] [ \begin{matrix}cos ( - {θ}_{z} ) & - sin ( - {θ}_{z} ) & 0 \\ sin ( - {θ}_{z} ) & cos ( - {θ}_{z} ) & 0 \\ 0 & 0 & 1\end{matrix} ] ( [ \begin{matrix}{a}_{x} \\ {a}_{y} \\ {a}_{z}\end{matrix} ] - [ \begin{matrix}{c}_{x} \\ {c}_{y} \\ {c}_{z}\end{matrix} ] ) ;$$

On the contrary, if position of the image retrieving module 104 is remaining unchanged, which means the shifting angle (θₓ, θ_{y}, θ_{z})=(0,0,0), and the projection mapping parameter D (dₓ, d_{y}, d_{z}) can be acquired by following formula:

(dₓ,d_{y},d_{z})=(aₓ,a_{y},a_{z})−(cₓ,c_{y},c_{z}).

Therefore, while the processing unit 101 selectively projects an image object 2032-1, such as a butterfly, in the real scene of flowering shrubs (S220), the processing unit 101 acquires a third coordinate information E corresponding to position where the image object 2032-1 is estimated to projected in the real scene and the third coordinate information E is expressed as (eₓ, e_{y}, e_{z}), wherein E represents the projection position where the scene object 2032-1 is expected to project in the real scene. The processing unit 101 calculates a projection coordinate information B according to the first coordinate information A, the second coordinate information C, the third coordinate information E and the projection parameter D and the projection coordinate information B is expressed as (bₓ, b_{y}), it is to say that where the image object 2032-1 in the first image information 202, the projection coordinate information B can be acquired by following formula:

$${b}_{x} = \frac{{e}_{x}}{{d}_{x}} {d}_{x} - {e}_{x}$$

$${b}_{z} = \frac{{e}_{z}}{{d}_{z}} {d}_{y} - {e}_{y} ,$$

and the processing unit 101 regenerates the second information 203 containing the image object 2032-1 through the application program (S230). The image projection module 103 reprojects the projection mapping information 204 in the real scene corresponding to the second image information 203. Therefore, in users or audience's view, the image of flowering shrubs is overlapping on flowering shrubs in the real scene, and the image of butterfly is appeared above flowering shrubs in the real scene. It is noted that the projection mapping information 204 will be projected as the butterflying is flying above flowering shrubs in the real scene as shown in FIG. 6C while the inserted image object 2032-1-2032-3 is a dynamic image object as shown in FIG. 6B.

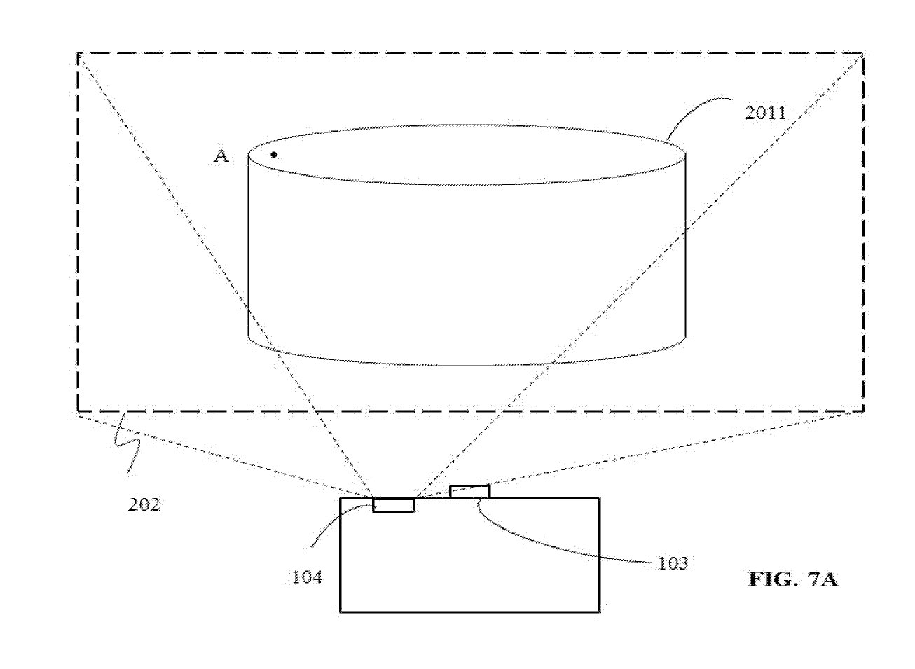

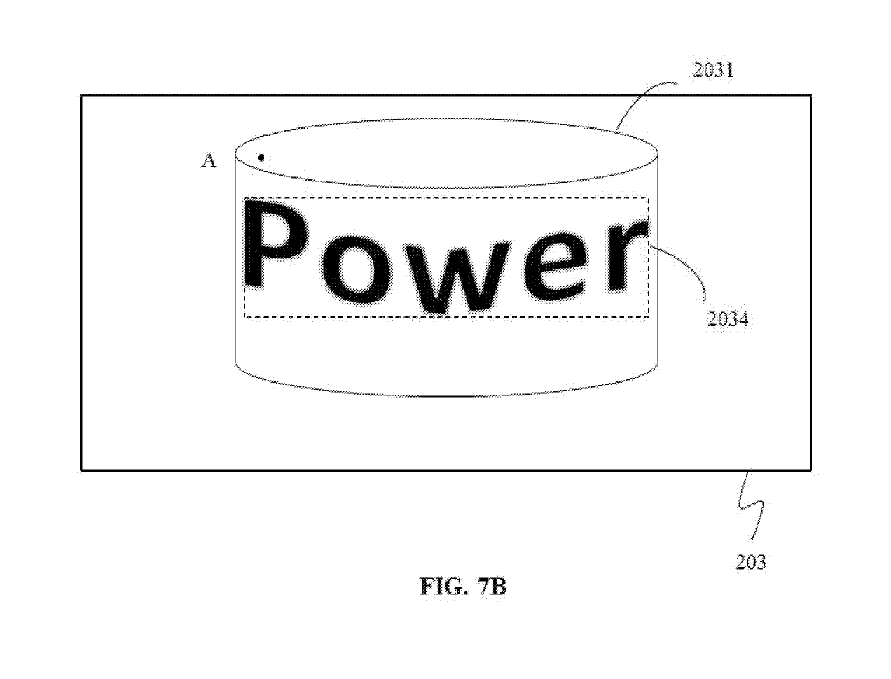

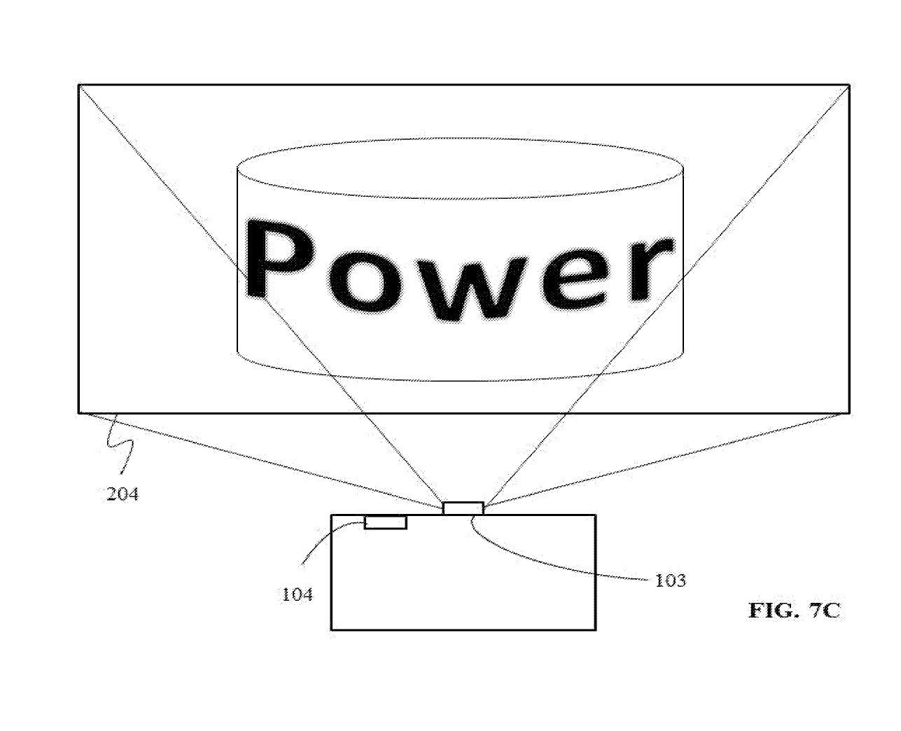

Demand in the second aspect of mentioned control system is to project required image on the three-dimensional substance and merge together. Referring to FIG. 5, and FIG. 7A to FIG. 7C, since some steps in the second embodiment is similar to the first embodiment, applicant will focus on the steps which are different, firstly, in step S201 in this embodiment, the scene object 2011 in the real scene is a cylinder, and in the step 205 of calculating the first coordinate information A of the scene object in the real scene, the first coordinate information A measurement is directed to whole outline of current scene object but represented by A. Secondly, calculation of the projection mapping parameter D have been considered in previous description and will not be repeated herein. Hence, while the processing unit 101 selectively project an image object 2034, such as a written characters Power, in the scene object 2031 in the real scene (S220), the processing unit 101 calculates the projection coordinate information B and regenerates the second image information 203 containing the image object 2034 (S230) as mentioned above, the image projection module 103 will project the projection mapping information 204 in the real scene corresponding to the second image information 203, Therefore, in user's or audience's sight, the written characters Power is projected on the cylinder in the real scene, and the written characters Power is fitted with the cambered side surface of the cylinder as the written characters Power is printed on the cylinder initially as to achieve effective of augmented reality.

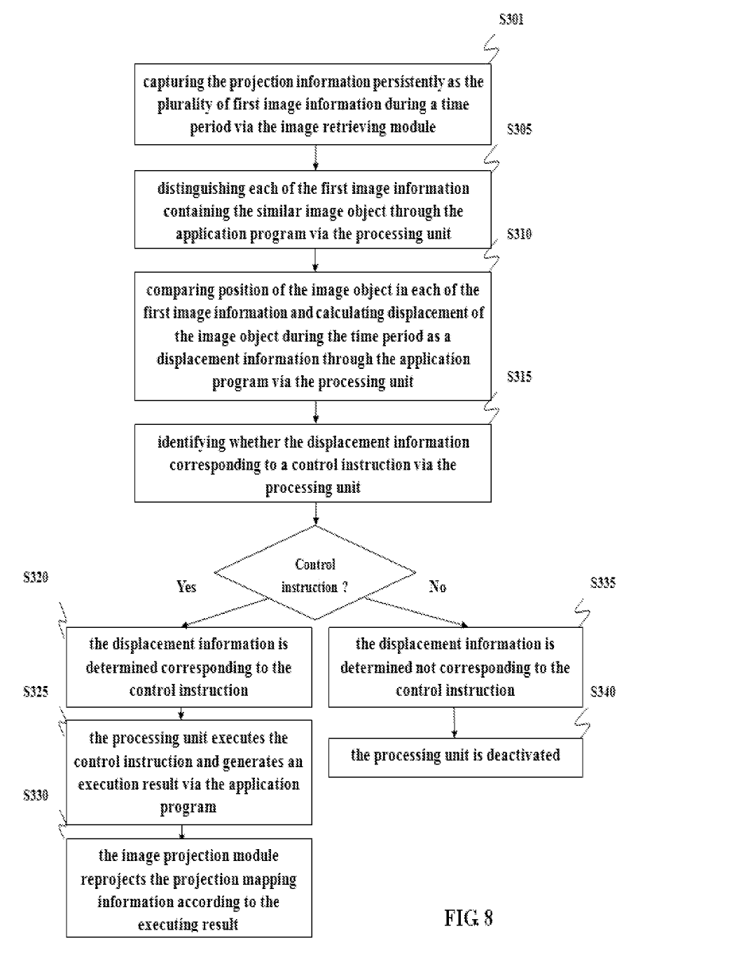

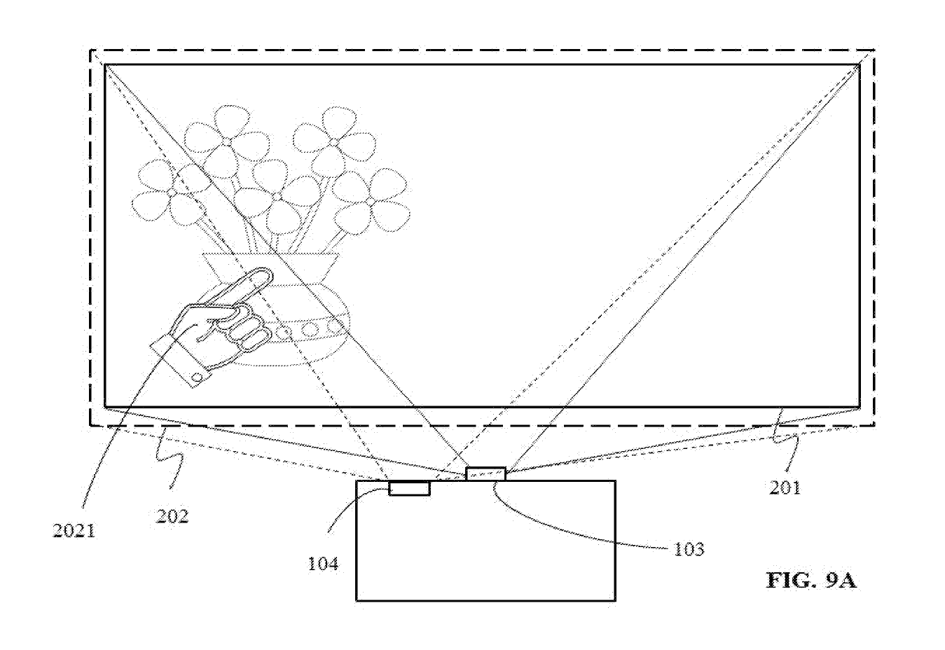

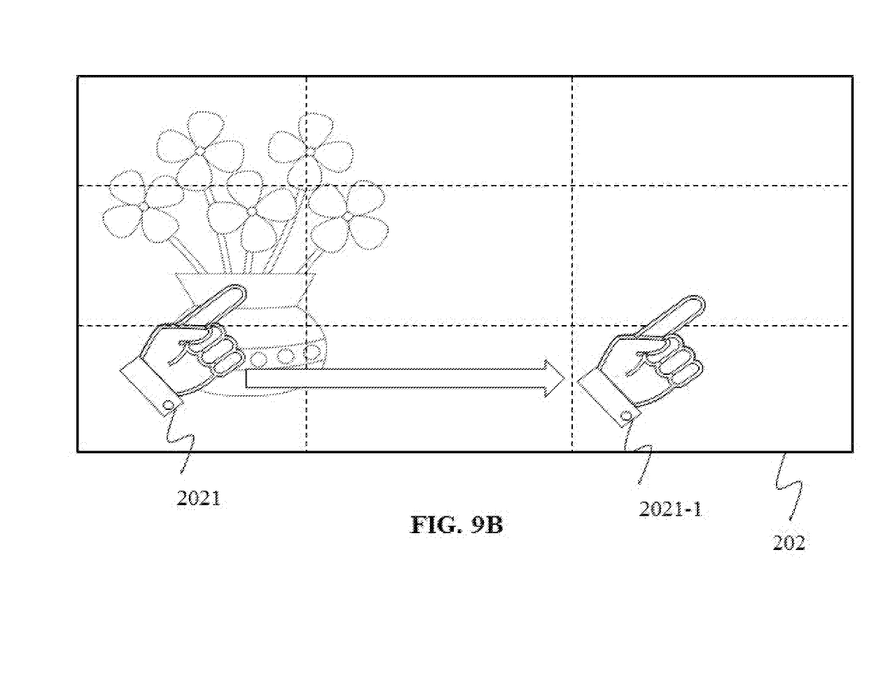

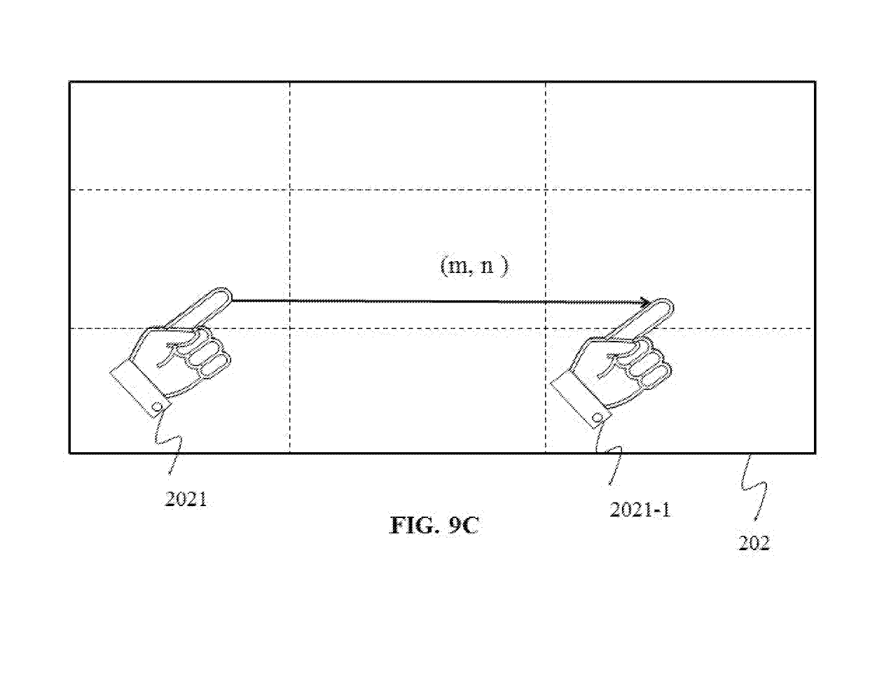

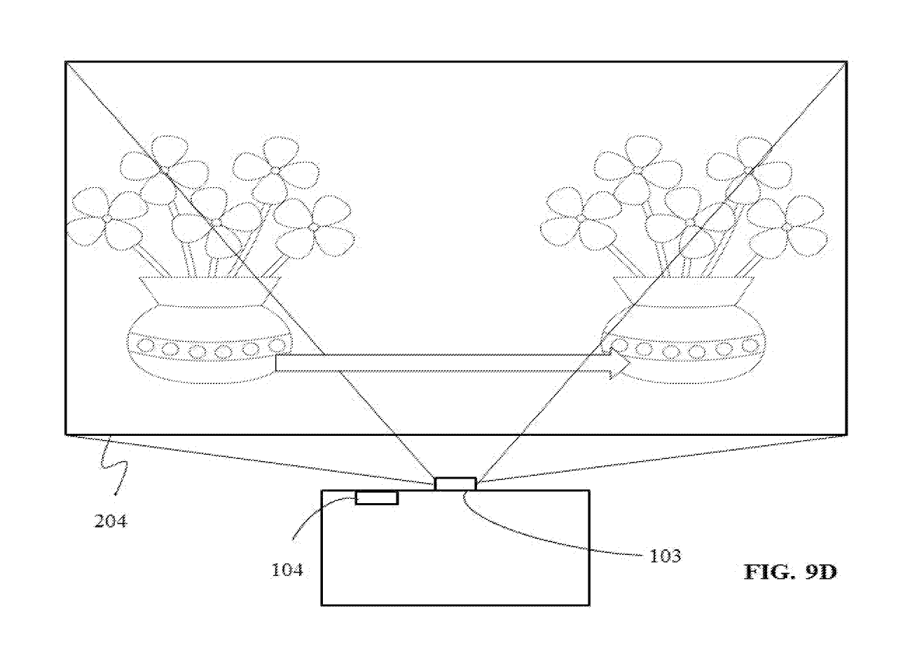

In the third embodiment, the control system in projection mapping disclosed in present invention is similar to the first embodiment, however the control method in projection mapping in this embodiment is focusing on projection image control in projection mapping. In other words, users may operate the tablet projector through controlling the projection image directly. Please refer to FIG. 8 to FIG. 9D, and also FIG. 1 and FIG. 2, the image retrieving module 104 captures the projection information 201 persistently as a plurality of first image information 202 during a time period, such as 2 seconds. In other words, the image retrieving module 104 keeps capturing the projection information 201 substantially during this time period (S301). Hence, while users touch any object, such as a vase picture in the projection information 201 with their fingers or other materials, the processing unit 101 distinguishes each of the first image information 201 containing the similar image object 2021 through the application program (S305). Such mechanism is for palm rejection, or preventing misjudgement caused by shadow of people who passes by. It is noted that length of the time period and amount of the first image information 202 captured during the time period are modified according to users need as to improve accuracy of identification.

Next, the processing unit 101 compares position of the image object 2021 in each of the first image information 202 and calculates displacement of the image object 2021 during the time period as a displacement information through the application program (S310), for example, the processing unit 101 determines position of the image object 2021 in each of the first image information 202 is shifted from original place 2021 to the new place 2021-1 as shown in FIG. 9B, the processing unit 101 calculates the displacement information (m, n) of the image object 2021 during the time period as shown in FIG. 9C accordingly. The processing unit 101 identifies whether the displacement information corresponding to a control instruction (S315), wherein if the processing unit 101 determines the displacement information is corresponding to the control instruction (S320), the processing unit 101 executes the control instruction and generates an execution result via the application program (S325), and the image projection module 103 reprojects the projection mapping information 204 according to the executing result (S330).

In detail, the processing unit 101 identifies whether the displacement information is corresponding to the displacement information built in the processing unit 101, if so, the displacement information is determined as the control instruction for execution. The displacement information and corresponding control instruction can be defined by people in this art, or new added to the processing unit 101 through the control method in projection mapping. Applicant will take the following examples for illustration:
(1) If the displacement information during the time period calculated by the processing unit 101 is (0, 0), it means that the image object 2021 in the time period remains staying in the same position, the processing unit 101 determines the displacement information corresponding to a clicking instruction, executes the clicking instruction and generates the execution result. As result, the processing unit 101 executes the clicking instruction direct to the vase in the image, and the image projection module 103 reprojects the projection mapping information 204 corresponding to the execution result. Hence, the image which the vase being clicked will be projected by the image projection module 103 following user's operation.
(2) If the displacement information during the time period calculated by the processing unit 101 is (m, n), it means that the image object 2021 in the time period have been shifted, the processing unit 101 determines the displacement information corresponding to a sliding instruction, executes the sliding instruction and generates the execution result. As result, the processing unit 101 executes the sliding instruction direct to the vase in the image, and the image projection module 103 reprojects the projection mapping information 204 corresponding to the execution result. Hence, the image which performing sliding motion will be projected by the image projection module 103 following user's operation.

It is noted that mentioned displacement information can be permutated or combined, the processing unit 101 determines the displacement information (m, n) in this time period, and the displacement information in the previous time period is (0, 0), which means the image object 2021 is stayed in the same place for a while first and then slided. The processing unit 101 will determine the displacement information corresponds to a dragging instruction, execute the dragging instruction and generate the execution result. As result, the processing unit 101 executes the dragging instruction direct to the vase in the image, and the image projection module 103 reprojects the projection mapping information 204 corresponding to the execution result. Hence, the image which have been dragged will be projected by the image projection module 103 following user's operation as shown in FIG. 9D.

As mentioned above, if the processing unit 101 determines the displacement information is not corresponding to the control instruction, the processing unit 101 is deactivated, and the projection information 201 projected by the image projection module 103 is unchanged accordingly. With help of the control method in this embodiment, users may operate the tablet projector to execute the control instruction corresponding to the application program by touching the projection image projected by the image projection module 103 directly. Furthermore, users may operate in front of the projection image to execute various operating function without touching the tablet projector or even touching the projection image during the commercial exhibition, presentation or image sharing as to improve convenience. Meanwhile, all operations corresponding to the gesture instructions will be appeared on the touch panel and projected by the image projection module synchronously and the users and the audiences may receive the same information at the same time.

It is noted that the control method in projection mapping mentioned in different embodiment are merely several illustrations and not limited. People with ordinary skills in the art may develop or deduct various gesture instructions as their demands without departing from the spirit of the present invention to achieve purpose of the projection mapping operation.

In the control system in projection mapping the control thereof as disclosed in mentioned embodiments of present invention, through retrieving projection information via the image retrieving module in the tablet projector, users are available for adding or modifying the image object immediately and reprojecting the projection mapping information which have been edited via the image projection module. Accordingly, present invention provides real-time projection image editing as to improve interaction with users and audience.

Secondly, in present invention, through retrieving the real scene as the image information via the image retrieving module in tablet projector, users may further add or modify the image object to the image information, and the image projection module reprojects the projection mapping information which have been edited accordingly. Therefore, mentioned projection mapping information can projected in the real scene and provide audiences with a spectacular sense of actually being there. In another aspect, mentioned projection mapping theory may also applied for projecting particular image on a three-dimensional (3D) object and projection angle can be verified corresponding to users' view angle, hence the projection mapping information projected on surface of the object is seemed natural and visual effect is improved strongly. Effective of projection mapping and augmented reality will satisfy audience's demand and provide vicarious pleasure.

Furthermore, through retrieving the image information via the image retrieving module in the tablet projector during a time period, displacement of the image object during the time period is identified and the control instruction corresponding to the displacement is determined accordingly. The control instruction is executed and the execution result will be reprojected by the image projection module. Hence, users' operation can merely direct to the projection image, the operation is determined through the control method in projection mapping and the execution result is reprojected by the image projection module accordingly. Consequently, real-time interaction between users and the table projector through operation directing to the projection image is fulfilled correspondingly.

In conclusion, the control system in projection mapping and the control method thereof disclosed in present invention not only provide basic image projection, but also produce various image result through user's interactive operation. Besides, image projection in present invention may combine with real scene and is not limited to project on two-dimensional (2D) surface. Accordingly, usefulness and range of image projection mapping applications is improved remarkably, which includes experiential exhibition, commercial, education as to satisfy user's different demands.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany embodiments.

What is claimed is:

1. A control system in projection mapping, comprising:
a processing unit, configured for executing an application program;
a touch panel, coupled to the processing unit, the touch panel configured for receiving a control motion and generating a control signal accordingly;
an image projection module, coupled to the processing unit, the processing unit configured for executing the control signal and controlling the image projection module to project a projection information through the application program; and
an image retrieving module, coupled to the processing unit, the image retrieving module configured for capturing the projection information as a first image information, wherein the processing unit is configured for selectively adding an image object to the first image information and regenerating a second image information through the application program, the image projection module reprojects a projection mapping information corresponding to the second image information.

2. The control system in projection mapping as claimed in claim 1, wherein the image retrieving module is configured for capturing a scene object in a real scene as the first image information, and measuring position of the scene object in the real scene as a first coordinate information, the processing unit is configured for measuring position of the image retrieving module in the real scene as a second coordinate information and calculating a projection parameter corresponding to the first coordinate information and the second coordinate information through the application program, wherein the processing unit acquires a third coordinate information corresponding to position where the image object is estimated to projected in the real scene, calculates a projection coordinate information according to the first coordinate information, the second coordinate information, the third coordinate information and the projection parameter and regenerates the second image information containing the image object through the application program as the processing unit is configured for selectively projecting the image object in the real scene, and the image projection module is configured for reprojecting the projection mapping information in the real scene corresponding to the second image information.

3. The control system in projection mapping as claimed in claim 1, wherein the image retrieving module is configured for capturing the projection information persistently as the plurality of first image information during a time period, wherein the processing unit distinguishes each of the first image information containing the similar image object, compares position of the image object in each of the first image information and calculates displacement of the image object during the time period as a displacement information through the application program, wherein the processing unit identifies the displacement information corresponding to a control instruction, executes the control instruction and generates an execution result via the application program, and the image projection module is configured for reprojecting the projection mapping information according to the executing result.

4. A control method in projection mapping, the method comprising:
receiving a control motion and generating a control signal via a touch panel accordingly;
executing the control signal and controlling an image projection module to project a projection information through an application program via a processing unit;
capturing the projection information as a first image information via an image retrieving module;
selectively adding an image object in the first image information and regenerating a second image information through the application program via the processing unit; and
reprojecting a projection mapping information corresponding to the second image information via the image projection module.

5. The control method in projection mapping as claimed in claim 4 further comprising:
capturing a scene object in a real scene as the first image information and measuring position of the scene object in the real scene as a first coordinate information via the image retrieving module;
measuring position of the image retrieving module in the real scene as a second coordinate information through the application program via the processing unit;
calculating a projection parameter corresponding to the first coordinate information and the second coordinate information through the application program via the processing unit;
wherein as the processing unit selectively projects the image object in the real scene, the processing unit acquires a third coordinate information corresponding to position where the image object is estimated to projected in the real scene;
the processing unit calculates a projection coordinate information according to the first coordinate information, the second coordinate information, the third coordinate information and the projection parameter and regenerates the second image information containing the image object through the application program; and
the image projection module reprojects the projection mapping information in the real scene corresponding to the second image information.

6. The control method in projection mapping as claimed in claim 5, wherein in step of calculating the projection parameter corresponding to the first coordinate information and the second coordinate information through the application program via the processing unit, the projection parameter is defined as (dₓ, d_{y}, d_{z}), the first coordinate information where the scene object located in the real scene is defined as (aₓ, a_{y}, a_{z}), the second coordinate information where the image retrieving module located in the real scene is defined as (cₓ, c_{y}, c_{z}), a shifting angle of the image retrieving module is defined as (θₓ, θ_{y}, θ_{z}); and the following formula is satisfied:
$$[ \begin{matrix}{d}_{x} \\ {d}_{y } \\ {d}_{z}\end{matrix} ] = [ \begin{matrix}1 & 0 & 0 \\ 0 & cos ( - {θ}_{x} ) & - sin ( {θ}_{x} ) \\ 0 & sin ( - {θ}_{x} ) & cos ( - {θ}_{x} )\end{matrix} ] [ \begin{matrix}cos ( - {θ}_{y} ) & 0 & sin ( - {θ}_{y} ) \\ 0 & 1 & 0 \\ - sin ( {θ}_{y} ) & 0 & cos ( - {θ}_{y} )\end{matrix} ] [ \begin{matrix}cos ( - {θ}_{z} ) & - sin ( - {θ}_{z} ) & 0 \\ sin ( - {θ}_{z} ) & cos ( - {θ}_{z} ) & 0 \\ 0 & 0 & 1\end{matrix} ] ( [ \begin{matrix}{a}_{x} \\ {a}_{y} \\ {a}_{z}\end{matrix} ] - [ \begin{matrix}{c}_{x} \\ {c}_{y} \\ {c}_{z}\end{matrix} ] ) .$$

7. The control method in projection mapping as claimed in claim 6, wherein in step of calculating the projection parameter corresponding to the first coordinate information and the second coordinate information through the application program via the processing unit, position of the image retrieving module is remaining unchanged, the shifting angle (θₓ, θ_{y}, θ_{z})=(0,0,0), and the following formula is satisfied:
(dₓ,d_{y},d_{z})=(aₓ,a_{y},a_{z})−(cₓ,c_{y},c_{z}).

8. The control method in projection mapping as claimed in claim 6, wherein in the step of calculating the projection coordinate information according to the first coordinate information, the second coordinate information, the third coordinate information and the projection parameter and regenerates the second image information containing the image object through the application program, the projection coordinate information is defined as (bₓ, b_{y}), the third coordinate information where the image object is estimated to projected in the real scene is defined as (eₓ, e_{y}, e_{z}), and the following formulae are satisfied:
$${b}_{x} = \frac{{e}_{x}}{{d}_{x}} {d}_{x} - {e}_{x}$$
$${b}_{z} = \frac{{e}_{z}}{{d}_{z}} {d}_{y} - {e}_{y} .$$

9. The control method in projection mapping as claimed in claim 4, further comprising:
capturing the projection information persistently as the plurality of first image information during a time period via the image retrieving module;
distinguishing each of the first image information containing the similar image object through the application program via the processing unit;
comparing position of the image object in each of the first image information and calculating displacement of the image object during the time period as a displacement information through the application program via the processing unit;
identifying whether the displacement information corresponding to a control instruction via the processing unit, wherein if the displacement information is determined corresponding to the control instruction, the processing unit executes the control instruction and generates an execution result via the application program, and the image projection module reprojects the projection mapping information according to the executing result; or wherein if the displacement information is determined not corresponding to the control instruction, the processing unit is deactivated.

10. The control method in projection mapping as claimed in claim 9, wherein in the step of identifying whether the displacement information corresponding to a control instruction via the processing unit, wherein if the displacement information is determined corresponding to a clicking instruction, the processing unit executes the clicking instruction and generates the execution result via the application program accordingly; wherein if the displacement information is determined corresponding to a sliding instruction, the processing unit executes the sliding instruction and generates the execution result via the application program accordingly.
